(19) United States
(12) Patent Application Publication
(10) Pub. No.: US 2012/0167919 A1
(43) Pub. Date: Jul. 5, 2012

(54) FAN FRIEND CLEANING SYSTEMS

(76) Inventor: Jeffrey Kunes, Laveen, AZ (US)

(21) Appl. No.: 13/313,251

(22) Filed: Dec. 7, 2011

Related U.S. Application Data
(60) Provisional application No. 61/429,645, filed on Jan. 4, 2011.

(51) Int. Cl. A47L 9/06; A47L 9/24; B08B 5/04

(52) U.S. Cl. 134/6; 15/394

(57) ABSTRACT

A ceiling fan blade cleaning system including a vacuum attachment, configured expressly to be easily secured to virtually any household vacuum cleaner or industrial shop vac nozzle for convenience of the user in cleaning ceiling fan blades. The device is designed specifically to effectively eradicate dust, pollen, pet dander and other agents from all sides of a ceiling fan blade simultaneously, thereby preventing these agents from infiltrating a room's environment.

### CROSS-REFERENCE TO RELATED APPLICATION

The present application is related to and claims priority from prior provisional application Ser. No. 61/429,645, filed Jan. 4, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of ceiling fans and cleaning devices and more specifically relates to a ceiling fan cleaning device.

### 2. Description of the Related Art

Many modern buildings have heating and air-conditioning systems to regulate temperatures within the structures. Buildings often have ceiling fans installed to circulate air to remove heat or push heat towards the occupants of those buildings. Often these fans comprise multiple blades which may become laden with dust. Unfortunately, dust, dirt, allergens and debris, can be quickly and easily distributed through a living area via a standard ceiling fan, which may cause poor health to occupants and furniture and the like to become dirty. While ceiling fans offer consumers an energy efficient means of cooling their environments, these fans may be a nuisance to keep clean so they work properly.

Cleaning fan blades traditionally requires carefully manually wiping away dirt and debris that has settled on the upper blade surface with a dust cloth, paper towel or other similar cleaning means. This cleaning means often imparts the majority of the dust onto the entire area below the fan. Some individuals may use compressed air to blow off the tops of the blades however this too results in a similar outcome. It is desirable that an efficient cleaning means be used so that the dust, allergens are contained and eliminated in a controlled manner.

Various attempts have been made to solve problems found in the cleaning devices art. Among these are found in: U.S. Pat. No. 4,823,431 to Weda B. Carpenter; U.S. Pat. No. 5,319,821 to Roy V. Nicholson et al; and U.S. Pat. No. 4,841,592 to David J. Restivo. This prior art is representative of fan blade cleaning means.

None of the above inventions and patents, taken either singly or in combination, is seen to describe the invention as claimed. Thus, a need exists for a reliable ceiling fan cleaning device for use in cleaning ceiling fan blades, and to avoid the above-mentioned problems.

### BRIEF SUMMARY OF THE INVENTION

In view of the foregoing disadvantages inherent in the known ceiling fan art, the present invention provides a novel ceiling fan blade cleaning system. The general purpose of the present invention, which will be described subsequently in greater detail is to provide a controlled and contained means by which to clean ceiling fan blades.

Generally speaking, Fan Friend of the present invention (ceiling fan blade cleaning system) comprises a specially designed vacuum attachment, configured expressly to be easily secured to virtually any household vacuum cleaner (implement/canister) or industrial shop vac nozzle for convenience of the user. The device is designed specifically to effectively eradicate dust, pollen, pet dander and other agents from all sides of a ceiling fan blade simultaneously, thereby preventing these agents from infiltrating and contaminating a room's environment.

The Fan Friend preferably comprises a substantially rectangular-shaped, hollow vacuum nozzle, with the center of the unit open, designed to easily slide over the fan blade(s) to create a brush/vacuum cleaning means. The device is preferably manufactured primarily of a lightweight, yet durable/heavy duty plastic material although it may comprise other equivalent materials. The sides of this novel vacuum nozzle may feature adjustable (telescoping or the like) components, enabling the user to lengthen or shorten both the width and length of the device to accommodate the relative dimensions/profile of the ceiling fan blades being cleaned.

Centrally positioned on one side of the unit may be a cylindrical shaped sleeve designed to be secured over virtually any existing vacuum nozzle or shop vac nozzle. Running the perimeter of the interior (inner periphery) of the Fan Friend is a series of stiff, fiber bristles (or made from other suitable equivalent) designed to loosen dirt and debris adhering to the surface(s) of the fan blade. In certain alternate embodiments these bristles may be caused to vibrate to loosen debris. Further, a felt banding (felt rib) may also be included to efficiently trap and collect dust, pollen and other microscopic contaminants including the debris potentially missed by the fiber bristles. A series of openings may also be incorporated into the design of the Fan Friend, through which the debris would be suctioned, via the force of the existing vacuum cleaner.

A ceiling fan blade cleaning system is disclosed herein, in a preferred embodiment comprising: a cleaning head attachment assembly having a cleaning head attachment housing including: a ring rim (including; a left side; a right side; a top side; a bottom side; an inner periphery; an inner volume; an outer surface); six accordion adjusters; apertures in the ring rim; a vacuum hose connector end; a plurality of bristles; at least one felt rib; and a safety shield having containment ends. The cleaning head attachment assembly preferably comprises the plurality of bristles connected about the inner periphery of the cleaning head attachment housing. The cleaning head attachment housing comprises the ring rim (substantially rectangular with curved edges) integrally molded with the vacuum hose connector end.

The inner periphery and the outer surface of the ring rim define the confines of the inner volume (spatially.) The ring rim is defined in (volume and area) by the left and right sides; and top and bottom sides. The left side; right side; top side; and bottom side of the ring rim are each adjustable in relation to each other via accordion adjusters strategically located about the ring rim. The ring rim comprises exactly six of the accordion adjusters in preferred embodiments; the accordion adjusters comprising flexible joints such that the device can be manipulated to match various fan blade orientations/pitch/profiles. In preferred embodiments accordion adjusters are located on the left side of the rim ring allowing vertical adjustment of the left side of the rim ring. In a similar manner the accordion adjusters may be located on the right side of the rim ring allowing vertical adjustment of the right side of the rim ring. The side mounted accordion adjusters (one on each opposing side) are located about a midpoint of the right and left sides.

Two of the accordion adjusters are located on the top side of the rim ring allowing horizontal adjustment of the top side of the rim ring. Two of the accordion adjusters may be located on the bottom side of the rim ring allowing horizontal adjustment of the bottom side of the rim ring; wherein, as stated above, the accordion adjusters provide for vertical and horizontal adjustment of the rim ring in relation to a pitch, shape and size of the ceiling fan blade(s). These particular accordion adjusters are preferably located on the top and bottom sides, each one located adjacent the left and right sides. In this way the adjustments can be incremental or large and in most imaginable shapes and configurations (even including diamond-shaped.)

The bristles are preferably oriented inwardly-facing (along the length of the mouth and around the corner radiuses maintaining a contact-touch with the fan blade on all sides) in at least one line about the inner periphery of the cleaning head attachment housing of the cleaning head attachment assembly. The lines of bristles are substantially parallel to each other and to the outside edge of the mouth portion of the inner periphery of the rim ring. At least one felt rib is preferably located (parallel) between the lines of the bristles to catch the debris missed by the bristles.

The cleaning head attachment housing provides a substantially closed loop vacuum channel to deliver a negative-pressure to the apertures from the vacuum cleaner. The vacuum channel comprises a chamber wherein the negative-pressure may be communicated therewithin. The vacuum hose connector (that attaches the cleaning head attachment housing with the vacuum hose) comprises a funnel-shape in preferred embodiments and other shapes such as stepped/staged, uses adapters to fit or the like in alternate embodiments. In this way the present invention is readily adaptable for use with most standard hoses attached to existing vacuum implements.

Another novel feature, the safety shield is preferably parallel to a planar ground surface when the ceiling fan blade cleaning system is in an in-use condition (ceiling fan is not in use) such that the use of the device is relatively comfortable because the user is not working on an angle, but rather substantially perpendicular to the fan blade.

The apertures may be circular or slotted and a majority of the apertures are located in (through) the top side (into the inner volume—allowing airflow), the left side and the right side of the ring rim so as to direct a majority of the negative-pressure to a top planar surface of the ceiling fan blade and a minority of negative-pressure to the apertures which are located in the bottom side. The apertures are preferably located between the lines of the bristles, the lines being parallel. The inner periphery provides a passageway for insertion of a ceiling fan blade for contact with the bristles (and the felt) for the cleaning of the ceiling fan blade. The cleaning head attachment assembly is removably attachable to a vacuum hose via the vacuum hose connector end, the cleaning head attachment assembly in fluid communication with a vacuum cleaner to impart the negative-pressure to the ceiling fan blade via the apertures to remove debris off the ceiling fan blade.

A kit is also described herein preferably including a first cleaning head attachment assembly comprising the funnel-shape; a second cleaning head attachment assembly comprising a staged extrusion; a safety shield; replacement felt ribs and/or bristles; and a set of user instructions.

A method of using a ceiling fan blade cleaning system is disclosed herein preferably comprising the steps of: attaching a cleaning head attachment assembly to a vacuum implement; adjusting a ring rim of a cleaning head attachment housing to accommodate the dimensions of a ceiling fan blade, the ceiling fan blade inserted through an inner periphery adjacent the bristles and the felt rib(s) located on/in the ring rim. Next the activating step of the vacuum implement is initiated to create a negative pressure; and is followed by applying the negative pressure to the ceiling fan blade to dislodge, collect and remove debris located on the ceiling fan blade (dislodging created when the bristles in combination with the felt rib touch contact the debris to separate it from the fan blade surface.) When the device is slid over and down the fan blade, The Fan Friend instantly suctions dirt, debris, hair, pet dander and virtually any other contaminants from the top, bottom and sides of the blade, simultaneously. This process may then be repeated until all ceiling fan blades have been cleaned. An optional step of removing the cleaning head attachment assembly from the vacuum implement may be performed such that the vacuum can be used for other purposes and the cleaning head attachment assembly stored for future use. Properly installed and adapted, The Fan Friend is efficient and effective in use.

The present invention holds significant improvements and serves as a ceiling fan blade cleaning system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ceiling fan blade cleaning systems, constructed and operative according to the teachings of the present invention.

FIG. 1 shows a perspective view illustrating a ceiling fan blade cleaning system in an in-use condition according to an embodiment of the present invention.

FIG. 2 is a perspective view illustrating a cleaning head attachment as used on a ceiling fan blade according to an embodiment of the present invention of FIG. 1.

FIG. 3A is a perspective view illustrating a cleaning head attachment according to an embodiment of the present invention of FIGS. 1 & 2.

FIG. 3B is a perspective view illustrating a cleaning head attachment according to an alternate embodiment of the present invention of FIG. 1.

FIG. 4 is a perspective view illustrating spatial and angular relationships of the various components of the ceiling fan blade cleaning system relative to an orientation of the ceiling fan blade on an installed ceiling fan according to an embodiment of the present invention of FIGS. 1-2.

FIG. 5 is a flowchart illustrating a method of using the ceiling fan blade cleaning system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a cleaning device and more particularly to a ceiling fan blade cleaning system as used to improve the ease and efficiency by which ceiling fan blades may be cleaned.

Generally speaking, there are many significant benefits and advantages associated with the Fan Friend of the ceiling fan blade cleaning system. The device enables consumers to clean their ceiling fans in a simple, safe and efficient manner. The vacuum cleaner attachment of the present invention is configured specifically to accommodate ceiling fan blades, but may also be used in different applications. The Fan Friend is able to easily suction dirt, dust and debris from all sides of the blade simultaneously, thus preventing this undesirable matter from contaminating the air within the room.

The device virtually eliminates the need to stir up piles of dust that quickly accumulate on the furniture and flooring beneath the fan; the Fan Friend contains dust, dirt, grime and allergens on contact and directs them to a vacuum cleaner via an attached vacuum hose for efficient removal; thus greatly reducing the amount of air born harmful allergens within the household environment. Simple to use, The Fan Friend is easily attached and quickly removed from any household vacuum in an almost effortless fashion. Although designed expressly for household use, the Fan Friend may be appreciated by housekeepers and professional maintenance workers, enabling these professionals to clean ceiling fans in a fraction of the time associated with traditional methods.

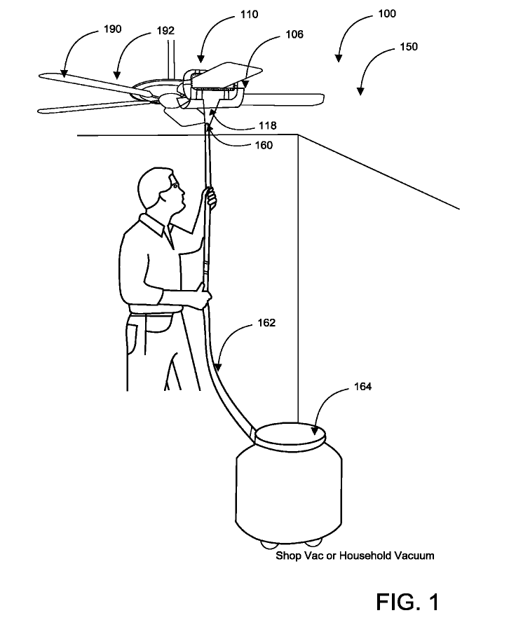

Referring now to the drawings specifically by numerals of reference there is shown in FIG. 1, a perspective view illustrating ceiling fan blade cleaning system 100 in in-use condition 150 according to an embodiment of the present invention.

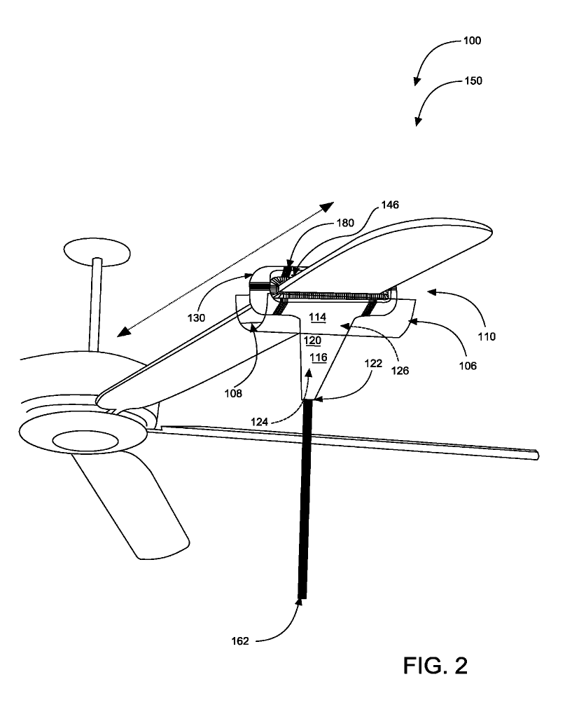

Ceiling fan blade cleaning system 100 may comprise: cleaning head attachment assembly 110 having cleaning head attachment housing 120 (including ring rim 130 having left side 132; right side 134; top side 136; bottom side 138; inner periphery 140; inner volume 142; outer surface 144; and apertures 146); vacuum hose connector end 160; and a plurality of bristles 170. Preferred embodiments also comprise felt rib 172 for thorough cleaning of debris from ceiling fan blades 190. Cleaning head attachment assembly 110 comprises plurality of bristles 170, bristles 170 connected about inner periphery 140 of cleaning head attachment housing 120. Inner periphery 140 provides a passageway for insertion of ceiling fan blade 190 for contact with bristles 170 for cleaning of ceiling fan blade 190. Bristles 170 and felt rib 172 are designed to touch-contact ceiling fan blade 190 to remove the debris located thereon. Direction of motion is generally indicated via directional arrow in FIG. 2. Cleaning head attachment housing 120 comprises ring rim 130 integrally molded with vacuum hose connector end 160 such that the present invention may be connected to vacuum hose 162.

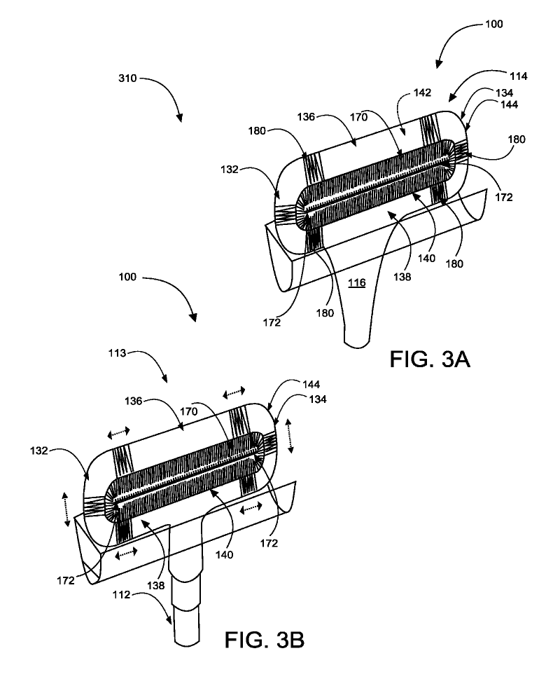

Inner periphery 140 and outer surface 144 of ring rim 130 define confines of inner volume 142. Ring rim 130 is defined by left side 132; right side 134; top side 136; and bottom side 138. Left side 132; right side 134; top side 136; and bottom side 138 of ring rim 130 are each adjustable in relation to each other via accordion adjusters 180 located about ring rim 130, as indicated in FIG. 3B.

Bristles 170 are preferably oriented inwardly-facing in at least one line about inner periphery 140 of cleaning head attachment housing 120 of cleaning head attachment assembly 110. Cleaning head attachment housing 120 provides a substantially closed loop vacuum channel 124 to deliver a negative-pressure to apertures 146. Vacuum channel 124 comprises chamber 126 wherein negative-pressure may be communicated therewithin to remove debris dislodged by bristles 170 and felt rib 172.

Cleaning head attachment assembly 110 is removably attachable to vacuum hose 162 via vacuum hose connector end 160, cleaning head attachment assembly 110 in fluid communication with vacuum cleaner 164 to impart the negative-pressure (vacuum) to ceiling fan blade 190 via apertures 146 to remove debris off ceiling fan blade 190. In this way the present invention may be effectively and efficiently used to clean ceiling fan blades 190 of ceiling fan 192.

Referring now to FIG. 2, showing cleaning head attachment 118 as used on ceiling fan blade 190 according to an embodiment of the present invention of FIG. 1.

Bristles 170 are oriented inwardly-facing in lines, as previously mentioned, lines of bristles 170 being (substantially) parallel to each other. In preferred embodiments ceiling fan blade cleaning system 100 further comprises at least one felt rib 172 which may be located between lines of bristles 170 to catch (collect and hold) debris missed by bristles 170. Felt rib 172 is also used in preferred embodiments because of the surface consistency to hold debris rather than simply cut through it as bristles 170 used alone may do.

A majority of suction is diverted to be directed on (to) a top set of holes (apertures 146.) Preferably, a greater number of holes (apertures 146) are located on the top (underneath of top side 136, side facing and adjacent ceiling fan blade 190.) Apertures 146 comprising slots (elliptical-shaped holes) may be used and different numbers of holes (apertures 146) may be used on the top and bottom, preferably more on the top to create better suction capability. Apertures 146 are preferably located in top side 136 of ring rim 130 within inner periphery 140 so as to direct a majority of negative-pressure to a top planar surface of ceiling fan blade 190 to suitably clean ceiling fan blade(s) 190 of ceiling fan 192.

Holes (apertures 146) may be placed at different locations such as on the outside of the rows of bristles 170 (as shown in FIG. 2) or inside them (preferred) or on both the outside and the inside in alternate embodiments. A baffle (not shown) may be used within cleaning head attachment 118 to divert airflow volume in certain embodiments. Preferably a felt edge, felt rib 172 (or felt-like equivalent material) is located between the rows of bristles 170 to catch lint/dust/debris that may be missed or is just dislodged but not fully removed by bristles 170. Upon reading this specification, it should be appreciated that, under appropriate circumstances, considering such issues as user preferences, design preference, structural requirements, marketing preferences, cost, available materials, technological advances, etc., other materials such as, for example, other fabrics, cloth, textile, webbing, soft plastics, natural and manmade fibers, etc., may be sufficient. In certain embodiments a fluid mister means may be used.

Referring now to FIG. 3A, a perspective view illustrating cleaning head attachment 118 according to an embodiment of the present invention of FIGS. 1 & 2.

Vacuum hose connector 122 of cleaning head attachment housing 120 comprises a funnel-shape 116 in certain embodiments as shown in the present figure and in FIGS. 1-2 and 4. Also shown in the present figure is that the present invention comprises accordion adjusters 180, accordion-style flexible joints using folded pleats (preferably six—two on the sides, left side 132 and right side 134, as shown and one on each side of the bottom and top bottom side 138 and top side 136, respectively) that allow the instant invention to be custom-fit to ceiling fan blade 190, such that cleaning head attachment assembly 110 can be adjusted diagonally/horizontally/vertically into virtually any profile. Various profiles may include differing pitches, curves, compound curves, different widths, different thicknesses of ceiling fan blade 190 and the like. The present invention may be adjusted from small standard/non-standard sized ceiling fan blades 190 to custom large ceiling fan blades 190. The range of adjustment permitted may increase or decrease the overall size of cleaning head attachment assembly 110, and various sizes to accommodate this are envisioned and are considered within the scope of the disclosure. Cleaning head attachment 118 according to the embodiment shown in FIG. 3A comprises first cleaning head attachment assembly 114. This particular embodiment may also comprise a baffle (not shown) located on inner volume 142.

FIG. 3B is a perspective view illustrating another version of cleaning head attachment 118 (second cleaning head attachment assembly 113) according to an alternate embodiment of the present invention of FIG. 1.

Cleaning head attachment 118 according to the embodiment shown in FIG. 3B comprises second cleaning head attachment assembly 113; vacuum hose connector 122 comprising staged extrusion 112. Staged extrusion 112 may be tapered in certain embodiments to ‘suction-seal-fit’ to vacuum hose 162. In other embodiments staged extrusion 112 may be telescopic. Seals and gaskets may also be used as well as clips and locks to couple the present invention in a desired sealable manner. Upon reading this specification, it should be appreciated that, under appropriate circumstances, considering such issues as user preferences, design preference, structural requirements, marketing preferences, cost, available materials, technological advances, etc., other adjustable means and arrangements such as, for example, telescoping, sliding, camming, etc., may be sufficient. Rubber seals may be used on staged extrusion 112 of second cleaning head attachment assembly 113, especially the telescopic versions or stepped versions (staged extrusion 112) meant to fit to multiple sized ends of vacuum hoses 162. Other adapters may be included in kit 310 to allow the device to be fit to various sized diameter hose ends of vacuum hoses 162 from vacuum cleaner 164 such as shop vacuums and the like.

Ring rim 130 comprises exactly six of accordion adjusters 180 in preferred embodiments, as previously mentioned and shown in the present figure; accordion adjusters 180 comprising flexible joints that are folded pleats or other suitable equivalent. Accordion adjusters 180 are preferably located on left side 132 of rim ring 130 allowing vertical adjustment (indicated by directional arrows) of left side 132 of rim ring 130. Accordion adjusters 180 may also be located on right side 134 of rim ring 130 thereby allowing vertical adjustment (indicated by directional arrows) of right side 134 of rim ring 130. In a similar manner, accordion adjusters 180 are preferably also located on top side 136 of rim ring 130 allowing horizontal adjustment (indicated by directional arrows) of top side 136 of rim ring 130. Accordion adjusters 180 of ceiling fan blade cleaning system 100 are also preferably located on bottom side 138 of rim ring 130 allowing horizontal adjustment (indicated by directional arrows) of bottom side 138 of rim ring 130. In this way accordion adjusters 180 provide for vertical and horizontal adjustment (as indicated) of rim ring 130 in relation to a pitch and shape of ceiling fan blade 190.

Kit 310 associated with the present invention may include at least one first cleaning head attachment assembly 114 comprising funnel-shape 116 (shown in FIG. 3A); at least one second cleaning head attachment assembly 113 comprising staged extrusion 112 (shown in FIG. 3B); safety shield 106; replacement felt ribs 172 and a set of user instructions. Ceiling fan blade cleaning system 100 may thus be sold as kit 440; ceiling fan blade cleaning system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different adjustment/size combinations, different forms of bristles, felt ribs, parts may be sold separately, etc., may be sufficient.

In certain embodiments vacuum cleaner 164 may comprise a handheld vacuum implement. Certain embodiments may be used with smaller vacuums such as for example Dust Busters® that may or may not have telescoping poles (telescoping feature alluded to in FIG. 1). Although this product is designed as an aftermarket accessory or as an OEM product, the Fan Friend line may be expanded in the future to include handheld vacuum cleaners featuring the Fan Friend incorporated into their OEM design.

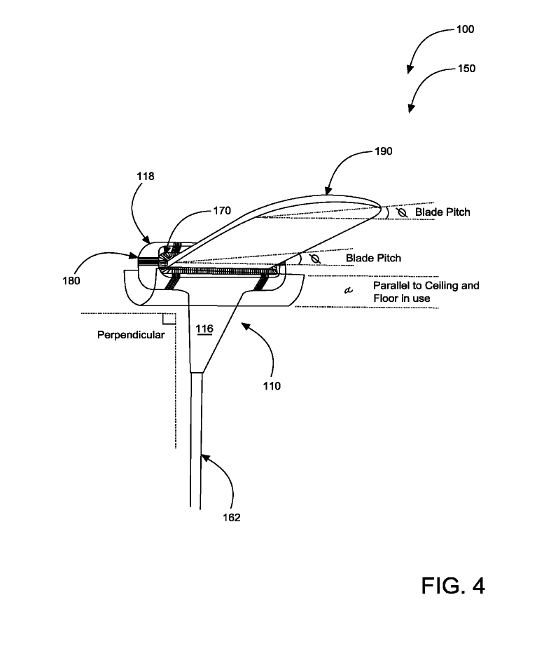

Referring now to FIG. 4, a perspective view illustrating spatial and angular relationships (indicated by angles designated α and ø) of the various components of ceiling fan blade cleaning system 100 relative to an orientation of ceiling fan blade 190 on an installed ceiling fan 192 according to an embodiment of the present invention of FIGS. 1-2.

Safety shield 106 preferably comprises ends 108, safety shield 106 parallel to a planar ground surface (and ceiling surface) when ceiling fan blade cleaning system 100 is in an in-use condition 150. Safety shield 106 may be used to catch weights for example that may become dislodged during in-use condition 150, or dustballs, small insects such as scorpions and the like, thus effectively preventing them from landing on the user-cleaner. Safety shield 106 may have small sides (ends 108) and these may be detachable or slidable in certain embodiments. Cleaning head attachment 118 (both first cleaning head attachment assembly 114 and second cleaning head attachment assembly 113) is molded such that vacuum hose 162 may be substantially perpendicular with the floor, the ceiling, and safety shield 106 (as indicated) and ring rim 130 of cleaning head attachment assembly 110 fitting over ceiling fan blade 190 is matched to orientate to the pitch of ceiling fan blade 190 so that the vacuum hose 162 may be straight up and down during in-use condition 150, as shown in FIG. 1. Safety shield 106 is parallel to the floor in this embodiment so as to evenly distribute any objects dropping therein.

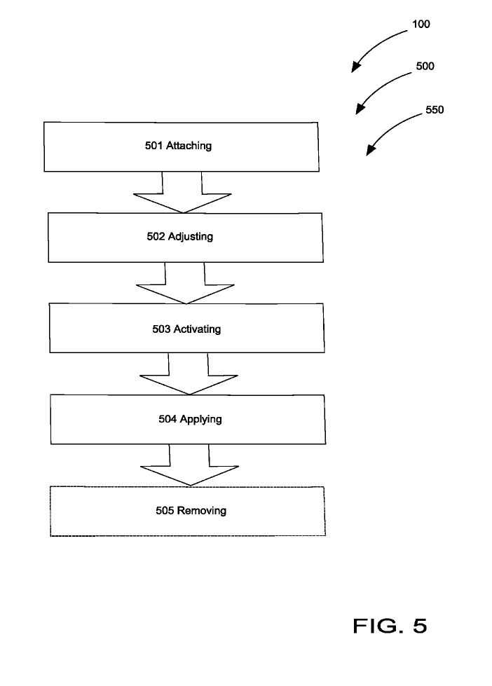

Referring now to FIG. 5, a flowchart 550 illustrating a method of using (method of use 500) ceiling fan blade cleaning system 100 according to an embodiment of the present invention of FIGS. 1-4.

A method of using (method of use 500) ceiling fan blade cleaning system 100 comprises the steps of: step one 501 attaching cleaning head attachment assembly 110 to a vacuum implement (vacuum cleaner 164); step two 502 adjusting ring rim 130 of cleaning head attachment housing 120 to accommodate dimensions of at least one ceiling fan blade 190, ceiling fan blade 190 inserted through inner periphery 140 adjacent bristles 170 and at least one felt rib 172 located on ring rim 130; step three 503 activating vacuum implement (vacuum cleaner 164) to create a negative pressure; and step four 504 applying negative pressure to ceiling fan blade 190 to dislodge, collect and remove debris located on ceiling fan blade 190, the dislodge created when bristles 170 and felt rib 172 contact the debris. Optionally, step five 505 may comprise removing cleaning head attachment assembly 110 from vacuum implement (vacuum cleaner 164.) Other steps such as telescoping, further adjusting may also be included within the scope of method of use 500.

It should be noted that step five 505 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

We wish to add the claims to read as follows:

1. A ceiling fan blade cleaning system comprising:
a cleaning head attachment assembly having;
a cleaning head attachment housing having;
a ring rim including;
a left side;
a right side;
a top side;
a bottom side;
an inner periphery;
an inner volume;
an outer surface; and
apertures;
a vacuum hose connector end;
a plurality of bristles;
wherein said cleaning head attachment assembly comprises said plurality of bristles connected about said inner periphery of said cleaning head attachment housing;
wherein said cleaning head attachment housing comprises said ring rim integrally molded with said vacuum hose connector end;
wherein said inner periphery and said outer surface of said ring rim define confines of said inner volume;
wherein said ring rim is defined by said left side; said right side; said top side; and said bottom side;
wherein said left side; said right side; said top side; and said bottom side of said ring rim are each adjustable in relation to each other via accordion adjusters located about said ring rim;
wherein said bristles are oriented inwardly-facing in at least one line about said inner periphery of said cleaning head attachment housing of said cleaning head attachment assembly;
wherein said cleaning head attachment housing provides a substantially closed loop vacuum channel to deliver a negative-pressure to said apertures;
wherein said vacuum channel comprises a chamber wherein said negative-pressure may be communicated therewithin;
wherein said inner periphery provides a passageway for insertion of a ceiling fan blade for contact with said bristles for cleaning of said ceiling fan blade; and
wherein said cleaning head attachment assembly is removably attachable to a vacuum hose via said vacuum hose connector end, said cleaning head attachment assembly in fluid communication with a vacuum cleaner to impart said negative-pressure to said ceiling fan blade via said apertures to remove debris off said ceiling fan blade.

2. The ceiling fan blade cleaning system of claim 1 wherein said bristles are oriented inwardly-facing in lines, said lines of said bristles being parallel to each other.

3. The ceiling fan blade cleaning system of claim 2 further comprising at least one felt rib is located between said lines of said bristles to catch said debris missed by said bristles.

4. The ceiling fan blade cleaning system of claim 1 wherein said vacuum hose connector comprises a staged extrusion.

5. The ceiling fan blade cleaning system of claim 1 wherein said staged extrusion is tapered.

6. The ceiling fan blade cleaning system of claim 1 wherein said staged extrusion is telescopic.

7. The ceiling fan blade cleaning system of claim 1 wherein said ring rim comprises exactly six of said accordion adjusters, said accordion adjusters comprising flexible joints.

8. The ceiling fan blade cleaning system of claim 7 wherein one of said accordion adjusters is located on said left side of said rim ring allowing vertical adjustment of said left side of said rim ring.

9. The ceiling fan blade cleaning system of claim 7 wherein one of said accordion adjusters is located on said right side of said rim ring allowing vertical adjustment of said right side of said rim ring.

10. The ceiling fan blade cleaning system of claim 7 wherein two of said accordion adjusters are located on said top side of said rim ring allowing horizontal adjustment of said top side of said rim ring.

11. The ceiling fan blade cleaning system of claim 7 wherein two of said accordion adjusters are located on said bottom side of said rim ring allowing horizontal adjustment of said bottom side of said rim ring.

12. The ceiling fan blade cleaning system of claim 7 wherein said accordion adjusters provide for vertical and horizontal adjustment of said rim ring in relation to a pitch and shape of said ceiling fan blade.

13. The ceiling fan blade cleaning system of claim 1 further comprising a safety shield, said safety shield having ends, said safety shield parallel to a planar ground surface when said ceiling fan blade cleaning system is in an in-use condition.

14. The ceiling fan blade cleaning system of claim 1 wherein said apertures are located in said top side of said ring rim so as to direct a majority of said negative-pressure to a top planar surface of said ceiling fan blade.

15. The ceiling fan blade cleaning system of claim 14 further comprising a baffle.

16. The ceiling fan blade cleaning system of claim 1 wherein said vacuum cleaner comprises a handheld vacuum implement.

17. A ceiling fan blade cleaning system comprising:
a cleaning head attachment assembly having;
a cleaning head attachment housing having;
a ring rim including;
a left side;
a right side;
a top side;
a bottom side;
an inner periphery;
an inner volume;
an outer surface;
six accordion adjusters; and
apertures;
a vacuum hose connector end;
a plurality of bristles;
at least one felt rib; and
a safety shield having containment ends;
wherein said cleaning head attachment assembly comprises said plurality of bristles connected about said inner periphery of said cleaning head attachment housing;
wherein said cleaning head attachment housing comprises said ring rim integrally molded with said vacuum hose connector end;
wherein said inner periphery and said outer surface of said ring rim define confines of said inner volume;
wherein said ring rim is defined by said left side; said right side; said top side; and said bottom side;
wherein said left side; said right side; said top side; and said bottom side of said ring rim are each adjustable in relation to each other via accordion adjusters located about said ring rim;
wherein said ring rim comprises exactly six of said accordion adjusters, said accordion adjusters comprising flexible joints;
wherein one of said accordion adjusters is located on said left side of said rim ring allowing vertical adjustment of said left side of said rim ring;
wherein one of said accordion adjusters is located on said right side of said rim ring allowing vertical adjustment of said right side of said rim ring;
wherein two of said accordion adjusters are located on said top side of said rim ring allowing horizontal adjustment of said top side of said rim ring;
wherein two of said accordion adjusters are located on said bottom side of said rim ring allowing horizontal adjustment of said bottom side of said rim ring;
wherein said accordion adjusters provide for vertical and horizontal adjustment of said rim ring in relation to a pitch and shape of said ceiling fan blade;
wherein said bristles are oriented inwardly-facing in at least one line about said inner periphery of said cleaning head attachment housing of said cleaning head attachment assembly;
wherein said bristles are oriented inwardly-facing in lines, said lines of said bristles being parallel to each other;
wherein said felt rib is located between said lines of said bristles to catch said debris missed by said bristles;
wherein said cleaning head attachment housing provides a substantially closed loop vacuum channel to deliver a negative-pressure to said apertures;
wherein said vacuum channel comprises a chamber wherein said negative-pressure may be communicated therewithin;
wherein said vacuum hose connector comprises a funnel-shape;
wherein said safety shield is parallel to a planar ground surface when said ceiling fan blade cleaning system is in an in-use condition;
wherein said apertures are slotted and a majority of said apertures are located in said top side, said left side and said right side of said ring rim so as to direct a majority of said negative-pressure to a top planar surface of said ceiling fan blade and a minority to said apertures are located in said bottom side;
wherein said apertures are located between said lines of said bristles, said lines being parallel;
wherein said inner periphery provides a passageway for insertion of a ceiling fan blade for contact with said bristles for cleaning of said ceiling fan blade; and
wherein said cleaning head attachment assembly is removably attachable to a vacuum hose via said vacuum hose connector end, said cleaning head attachment assembly in fluid communication with a vacuum cleaner to impart said negative-pressure to said ceiling fan blade via said apertures to remove debris off said ceiling fan blade.

18. The ceiling fan blade cleaning system of claim 17 further comprising a kit including a first cleaning head attachment assembly comprising said funnel-shape; a second cleaning head attachment assembly comprising a staged extrusion; said safety shield; replacement said felt ribs and a set of user instructions.

19. A method of using a ceiling fan blade cleaning system comprising the steps of:
attaching a cleaning head attachment assembly to a vacuum implement;
adjusting a ring rim of a cleaning head attachment housing to accommodate dimensions of a ceiling fan blade, said ceiling fan blade inserted through an inner periphery adjacent bristles and a felt rib located on said ring rim;
activating said vacuum implement to create a negative pressure; and
applying said negative pressure to said ceiling fan blade to dislodge, collect and remove debris located on said ceiling fan blade, said dislodge created when said bristles and said felt rib contact said debris.

20. The method of claim 19 further comprising the step of removing said cleaning head attachment assembly from said vacuum implement.
